(19) United States
(12) Patent Application Publication
(10) Pub. No.: US 2011/0299195 A1
(43) Pub. Date: Dec. 8, 2011

(54) Row bar and wafer

(75) Inventors: Xianghua Liang, DongGuan (CN); Jibo Li, DongGuan (CN); Hui Yin, DongGuan (CN); Zeqing Jin, DongGuan (CN)

(73) Assignee: SAE Magnetics (H.K.) Ltd., Hong Kong (CN)

(21) Appl. No.: 12/805,655

(22) Filed: Aug. 11, 2010

(30) Foreign Application Priority Data
Jun. 3, 2010 (CN) CN 201010201043.8

(51) Int. Cl. G11B 21/00

(52) U.S. Cl. 360/234.3; G9B/21.023

(57) ABSTRACT

A row bar having a plurality of slider forming areas collocated and slider cutting areas formed between two adjacent slider forming areas respectively, the slider forming areas are eventually cut into individual sliders along the slider cutting areas respectively, each slider having a pole tip embedded therein and an air bearing surface pattern on an air bearing surface facing to a disk, and at least a regular measuring pattern with straight line is formed on one of the slider cutting areas, to serve as a frame of reference for measuring the position of the pole tip and the air bearing surface pattern. The present invention can improve the measuring accuracy, decrease the measuring error and, in turn, improve the performance of the slider.

### FIELD OF THE INVENTION

The present invention relates to the field of slider of disk drive device, more particularly, to a row bar with a plurality of sliders and a wafer with a plurality of row bars.

### BACKGROUND OF THE INVENTION

Hard disk drive incorporating rotating magnetic disks is commonly used for storing data in the magnetic media formed on the disk surfaces, and a magnetic recording head are used in hard disk drive to magnetically record information on a rotating disk.

Magnetic heads are typically constructed on a wafer that is sliced into separate row bars. Each row bar has a number of individual recording heads. The row bar is eventually sawed into individual elements and latter is assembled to a head gimbal assembly (HGA) of a hard disk drive.

A typical row bar 100 is shown in FIG. 1, which has a plurality of slider forming areas 101 collocated along a length direction thereof and slider cutting areas 103 formed between two adjacent slider forming areas 101. And the slider forming areas 101 are eventually cut into individual elements along the slider cutting areas 103 respectively, thereby obtaining an individual slider 102. As shown in FIG. 2a, the slider 102 has a leading edge 111, a trailing edge 113 and a slider body 112 formed therebetween. The trailing edge 113 has multiple bonding pads 118, such as four, to couple with a suspension (not shown) of the HGA. And a pole tip 117 with read and write elements (not shown) is embedded in the center of the trailing edge 113 for reading and writing operation. The slider body 112 has a surface facing to a disk (not shown) that is called an air bearing surface (ABS) 114. The ABS 114 has a cavity 115 with a suitable depth formed by a vacuum etching process and an ABS pattern 116 higher than the cavity 115 which is not etched. When the hard disk drive operates, a dynamic contact will be generated between the ABS 114 of slider 102 and the rotating disk with high speed, causing the slider 102 fly above the disk to read or write data. As shown in FIG. 2a, the ABS pattern 116 is regular and symmetrical.

Each slider of the row bar is typically tested before being sawed into individual components to insure that the magnetic heads comply with manufacturing specifications. For example, the position of the pole tip of the slider is very important to the alignment of the photo-mask and the row bar during the manufacturing process. On a photo-mask, a distance between the pole tip and the edge of the ABS pattern is determinate that is the standard of the manufacturing specification. It's desired that the above-mentioned distance after manufacturing is identical with the standard or within the range of allowable error. Thus, the distance between the pole tip and the edge of the ABS pattern will be measured before cutting the row bar.

Generally, a measurement of the regular ABS pattern with straight edge, such as the ABS pattern 116 shown in FIG. 2a-2b is easy to operation, which chooses a straight edge 131 as a frame of reference and then measure the distance between the pole tip 117 and the straight edge 131 by a specific measurement machine. It's an issue that measuring an irregular ABS pattern, however. Such an irregular ABS pattern 216 shown in FIG. 2c may have an asymmetrical pattern that has no straight edge or straight line, such that a standard frame of reference is difficult to be chosen and found for measuring. In actual operation, commonly, the operator chooses a line 211 on the ABS pattern 216 randomly or empirically as a frame of reference to measure the distance of its position and the pole tip 217 position. Therefore, generating an error during the measurement is inevitable and even frequent. Moreover, the error value will be determined by the experience of the different operator. Thus, such a measuring method will decrease the measuring accuracy greatly and, in turn, decreases the performance of the slider.

Hence, it is desired to provide an improved row bar and wafer that is easy to undergo a measurement to overcome the above-mentioned drawbacks.

### SUMMARY OF THE INVENTION

One aspect of the present invention is to provide a row bar with a regular measuring pattern with straight line as a frame of reference convenient for measuring the position of the pole tip and the air bearing surface pattern, which can increase the measuring accuracy and, in turn, improve the performance of the slider.

Another aspect of the present invention is to provide a wafer having at least a row bar with a regular measuring pattern with straight line as a frame of reference convenient for measuring the position of the pole tip and the air bearing surface pattern, which can increase the measuring accuracy and, in turn, improve the performance of the slider.

To achieve above objectives, a row bar is provide in the present invention, which having a plurality of slider forming areas collocated and slider cutting areas formed between two adjacent slider forming areas respectively, the slider forming areas are eventually cut into individual sliders along the slider cutting areas respectively, each slider having a pole tip embedded therein and an air bearing surface pattern on an air bearing surface facing to a disk, and at least a regular measuring pattern with straight line is formed on one of the slider cutting areas, to serve as a frame of reference for measuring the position of the pole tip and the air bearing surface pattern.

In a preferable embodiment, the regular measuring pattern is a T-shape pattern, which has a horizontal portion and a vertical portion perpendicular to each other.

Preferably, the horizontal portion has a width between 5 um to 200 um, and the vertical portion has a length between 10 um to 1000 um.

In another preferable embodiment, the regular measuring pattern is a cross-shape pattern or an L-shaped pattern.

Preferably, the row bar further comprises a cover pattern formed below the regular measuring pattern.

In yet another preferably embodiment, the row bar further comprises an identification mark formed on the regular measuring pattern to identify the position of the slider relative to a disk.

Preferably, the identification mark is a T-shape mark for marking a slider located on the upside of the disk.

Preferably, the identification mark is an L-shape mark for marking a slider located on the downside of the disk.

A wafer carrying at least a row bar formed thereon, the row bar having a plurality of slider forming areas collocated and slider cutting areas formed between two adjacent slider forming areas respectively, the slider forming areas are eventually cut into individual sliders along the slider cutting areas respectively, each slider having a pole tip embedded therein and an air bearing surface pattern on an air bearing surface facing to a disk, and at least a regular measuring pattern with straight line is formed on one of the slider cutting areas, to serve as a frame of reference for measuring the position of the pole tip and the air bearing surface pattern.

In comparison with the prior art, the present invention includes a regular measuring pattern with straight lines formed on the slider cutting area of the row bar, which is served as a frame of reference for measuring the position of the pole tip and the ABS pattern. When measure the row bar, the operator only measures the distance between the straight line of the pole tip, so as to measure out that whether the pole tip position and the ABS pattern position complies with the manufacturing specification. In such a design, the measuring process is simplified and is easy to perform, moreover, the measuring accuracy is improved greatly and the error rate is decreased evidently and, in turn, improves the performance of the slider.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 shows the structure of a conventional row bar with several sliders formed thereon;

FIG. 2a shows the perspective view of an individual slider of the row bar shown in FIG. 1;

FIG. 2b shows the plan structure of the slider shown in FIG. 2 with a regular ABS pattern formed thereon;

FIG. 2c shows the structure of a conventional slider with an irregular ABS pattern;

FIG. 3 shows the structure of a row bar according to a first embodiment of the present invention;

FIG. 4 is a partial view of the row bar shown in FIG. 3, that shows a detailed structure of the row bar;

FIG. 5 shows the detailed structure of the regular measuring pattern of row bar shown in FIG. 4 according to a first embodiment;

FIG. 6a shows the detailed structure of regular measuring pattern of row bar according to a second embodiment of the present invention;

FIG. 6b shows a regular measuring pattern of row bar according to a third embodiment of the present invention;

FIG. 7a shows the structure of a row bar according to another embodiment of the present invention;

FIG. 7b is a partial view of the row bar shown in FIG. 7a, that shows a detailed structure of the row bar;

FIG. 8a shows a first photo-mask of the ABS pattern during a first photolithography;

FIG. 8b shows a second photo-mask of the ABS pattern during a second photolithography;

FIG. 8c shows a third photo-mask of the ABS pattern during a third photolithography;

FIG. 9a shows the structure of a row bar with an identification mark according to a third embodiment of the present invention;

FIG. 9b shows several variable disposing directions of the identification mark shown in FIG. 9a;

FIG. 10a shows the structure of a row bar with an identification mark according to a fourth embodiment of the present invention;

FIG. 10b shows several variable disposing directions of the identification mark shown in FIG. 10a;

FIG. 11 is a comparison chart of measurement error of the present invention and the prior art; and

FIG. 12 is a wafer having several rows bar according to an embodiment of the present invention.

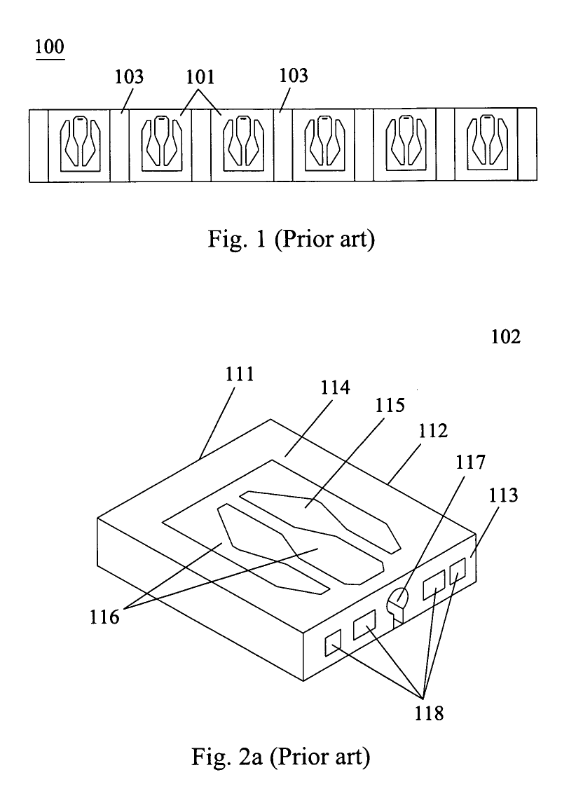

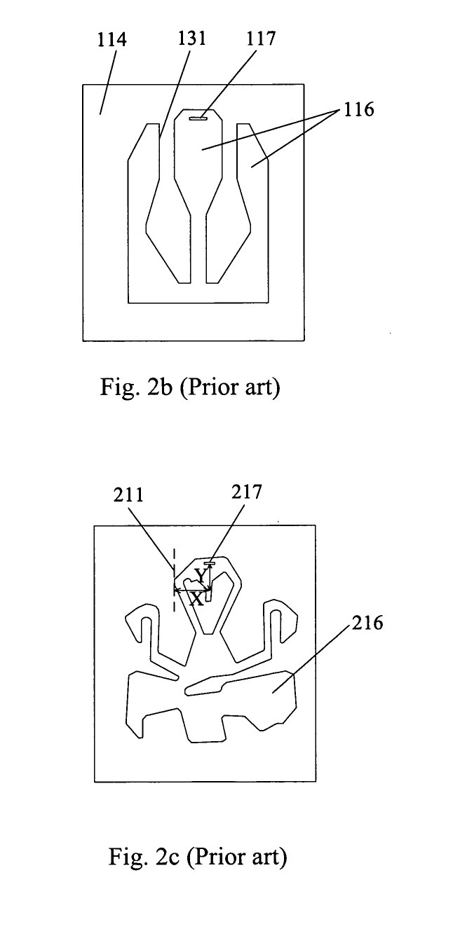

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a row bar having a plurality of slider forming areas collocated and slider cutting areas formed between two adjacent slider forming areas respectively, the slider forming areas are eventually cut into individual sliders along the slider cutting areas respectively, each slider having a pole tip embedded therein and an air bearing surface pattern on an air bearing surface facing to a disk, and at least a regular measuring pattern with straight line is formed on one of the slider cutting areas, to serve as a frame of reference for measuring the position of the pole tip and the air bearing surface pattern. In such a design, the present invention can improve the measuring accuracy, decrease the measuring error and, in turn, improve the performance of the slider.

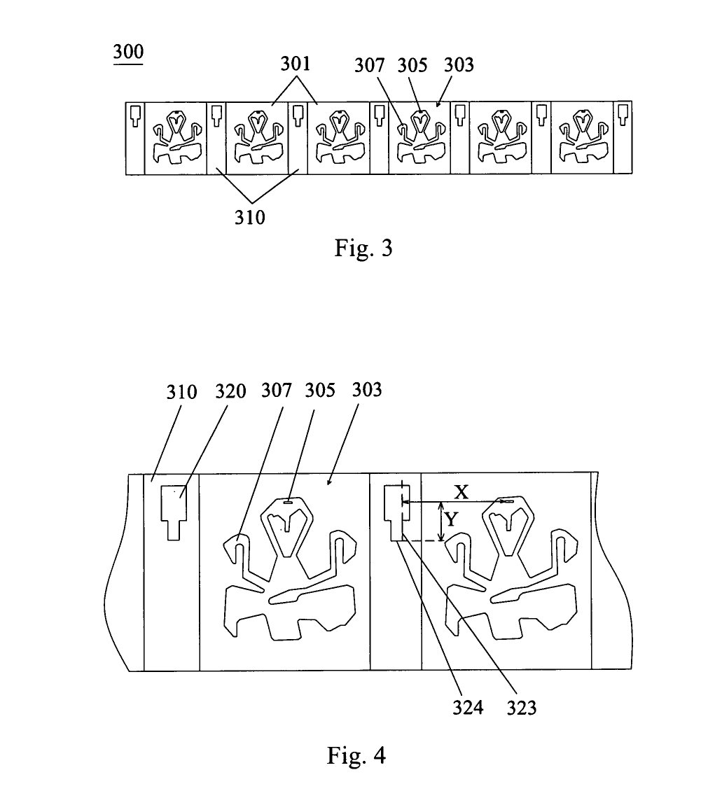

FIG. 3 shows the structure of a row bar 300 according to an embodiment of the present invention, and FIG. 4 is a partial enlarged view of the row bar 300 shown in FIG. 3, which shows a detailed structure of the row bar 300. As illustrated in FIGS. 3-4, the row bar 300 includes a plurality of sliders forming areas 301 collocated along a length direction of the row bar 300, and several slider cutting areas 310 formed adjacent to each slider forming area 301. Concretely, the sliders cutting areas 310 of the row bar 300 are formed between two adjacent slider forming areas 301. In the slider manufacturing process, the slider forming areas 301 are eventually cut into individual sliders 303 along the slider cutting areas 310 respectively. As shown, each slider 303 has a pole tip 305 embedded therein and an ABS pattern 307 formed on the ABS. Concretely, the pole tip 305 is formed in the center of the slider 303 adjacent to the trailing edge thereof, and the ABS pattern 307 is irregular and asymmetrical, which has no straight edge or straight line.

As shown in FIG. 4, the slider cutting area 310 adjacent to the slider forming area 301 has a regular measuring pattern that is shown a T-shape pattern 320. Preferably, the T-shape pattern 320 is set on the upper portion of the slider cutting area 310, which is adjacent to the pole tip 305. It should be noticed that the position of the T-shape pattern 320 can be arranged on the slider cutting area 310 randomly, which is not restricted in the upper portion of the slider cutting area 310.

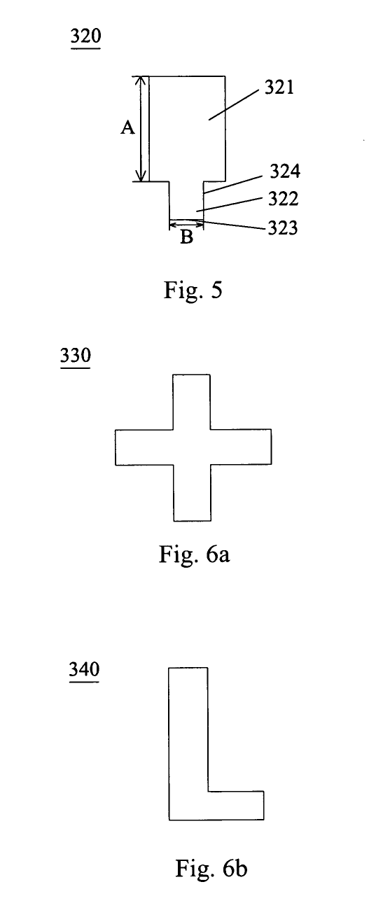

FIG. 5 shows the detailed structure of the regular measuring pattern of row bar 300 shown in FIG. 4. The T-shape pattern 320 has a horizontal portion 321 and a vertical portion 322 perpendicular to each other. Concretely, the horizontal portion 321 has a length A between 10 um to 1000 um, and the vertical portion 322 has a width B between Sum to 200 um. Preferably, the length A of the horizontal portion 321 is 500 um, and the width B of the vertical portion 322 is 50 um. In this embodiment, the T-shape pattern 320 having several straight lines is served as a frame of reference for measuring the distance between the pole tip 305 and the ABS pattern 307 edge. For example, referring to FIG. 4, the straight line 323 and the straight line 324 is chosen as a frame of reference. When the row bar 300 is tested, the operator only measures the distance X between the straight line 323 and the pole tip 305, or measure the distance Y between the straight line 324 and the pole tip 305, so as to measure out that whether the pole tip position and the ABS pattern position complies with the manufacturing specification.

As shown in FIGS. 6a-6b, the regular measuring pattern according the present invention is an L-shape pattern 330 or a cross-shape pattern 340, which also have a horizontal portion and a vertical portion being perpendicular to each other that have several straight lines served as a frame of reference similarly. It should be noticed that, the shapes of the regular measuring pattern are not restricted in the above-mentioned embodiments, any regular shape with straight lines is suitable.

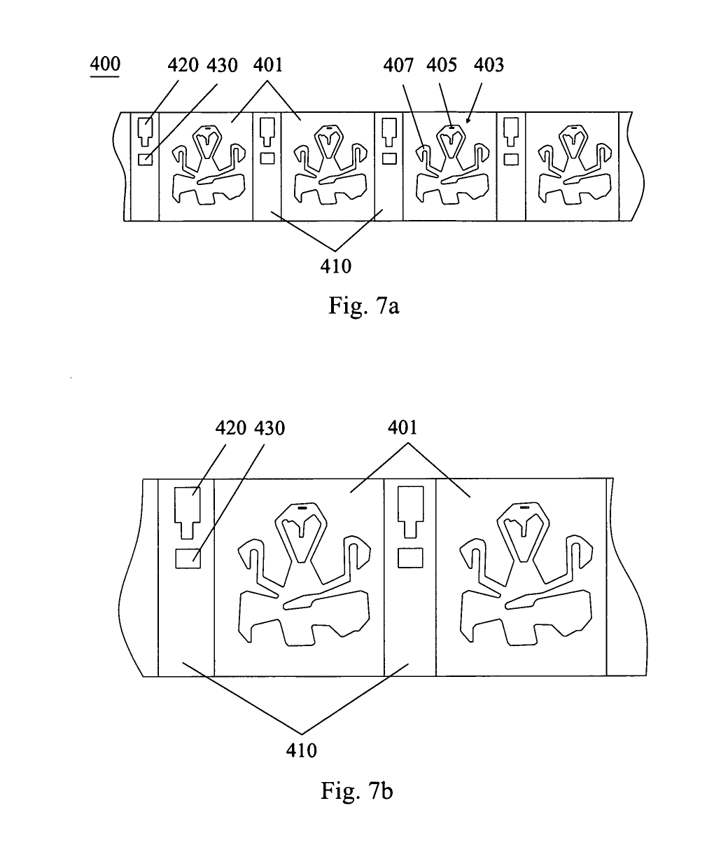

FIG. 7a shows a row bar according to another embodiment of the present invention, and FIG. 7b shows a detailed structure of the row bar. Similarly to the row bar 300 shown in the above embodiment, the row bar 400 includes a plurality of sliders forming areas 401 collocated along a length direction of the row bar 400, and several slider cutting areas 410 formed adjacent to each slider forming area 401. Concretely, the sliders cutting areas 410 of the row bar 400 are formed between every two adjacent slider forming areas 401. In the slider manufacturing process, the slider forming areas 401 are eventually cut into individual sliders 403 along the slider cutting areas 410 respectively. As shown, each slider 403 has a pole tip 405 embedded therein and an ABS pattern 407 formed on the ABS. Concretely, the pole tip 405 is formed in the center of the slider 403 adjacent to the trailing edge thereof, and the ABS pattern 407 is irregular and asymmetrical, which has no straight edge or straight line.

Similarly to the first embodiment of the row bar 300 shown in FIG. 5, a T-shape pattern 420 is formed on the slider cutting area 410, which is adjacent to the pole tip 405 of the slider 403. A difference is that the slider cutting area 410 further includes a cover pattern 430 formed below the T-shape pattern 420 after the manufacturing process. Moreover, a space between the T-shape pattern 420 and the cover pattern 430 is formed. A detailed description follows.

Typically, some ABS patterns are complicated and multilayer, that is, the ABS patterns may contain two or three layers, even more layers. For example, the ABS pattern 407 shown in the instant embodiment, which has three layers. Thus, the manufacture of such an ABS pattern 407 is much complicated than that of only one layer. It's known for the people skill in the art that one of the manufacturing processes thereof is photolithography. Commonly, the photolithography roughly includes photo-resist spraying, exposure, baking, development, etching and photo-resist removing. Thus, for the three-layer ABS pattern 407, a three-time photolithography will be performed, and three different photo-masks will be used.

Concretely, with regard to the above-mentioned ABS pattern's manufacturing, firstly, spraying the photo-resist to the surface that is being to become the ABS of the row bar by a dispenser, then transmitting a suitable exposure light, such as a ultraviolet radiation or a laser through a first photo-mask with a hollow pattern, thereby irradiating the photo-resist and causing it undergo a selective exposure, so as to obtain an exposed region; thirdly, baking the photo-resist so as to make the photo-resist attached on the row bar; then, developing the photo-resist, so as to remove the exposed region by the developer, thereby exposing the partial surface of the row bar; and then etching the surface that is exposed in the exposed region so as to form a specific geometry on the surface; finally, removing the rest photo-resist on the surface of the row bar, thereby finishing the photolithography of the first layer of ABS pattern.

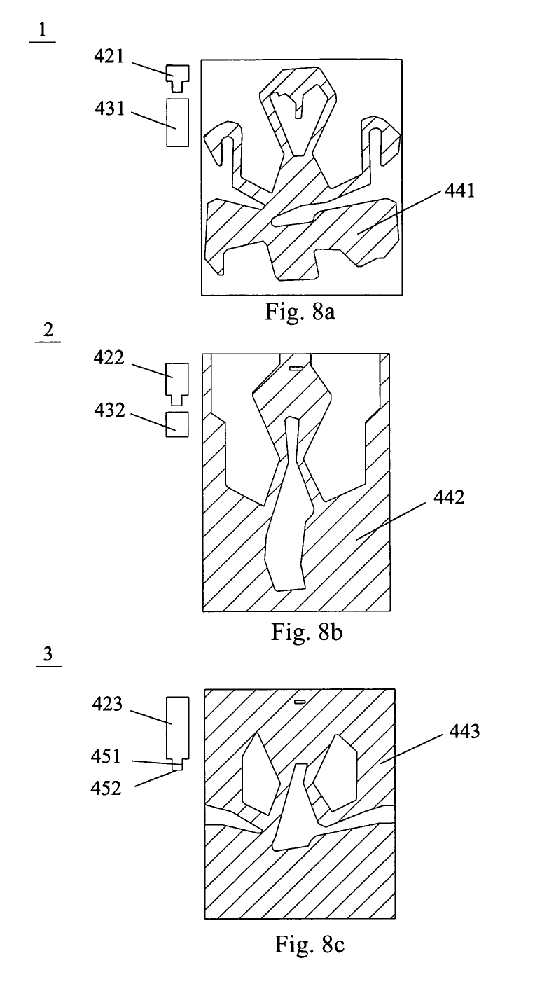

It should be noticed that, the pattern on the first photo-mask 1 is shown in FIG. 8a. As shown, besides the first layer 441 of the ABS pattern 407, a first cover pattern 431 is formed below a first T-shape pattern 421. The first cover pattern 431 is rectangular with a length of 10 um to 1000 um and a width of 5 um to 200 um. Preferably, the length is 500 um and the width is 100 um. The length of the horizontal portion of the first T-shape pattern 421 is 100 um, and the width of the vertical portion thereof is 50 um. And a space between the first T-shape pattern 421 and the first cover pattern 431 is formed. After the etching process of the photolithography above, the area of the first T-shape pattern 421 and the first cover pattern 431 is not etched, thus a fresh area not being etched can be used in the second photolithography. It's easy to know that the pattern obtained after the first photolithography is the same with that of the first photo-mask 1.

In the second photolithography, as shown in FIG. 8b, a second photo-mask 2 with a second pattern is used, which includes a second layer 442 of the ABS pattern 407, a second T-shape pattern 422 and a second cover pattern 432 formed below the T-shape pattern 422. Please refer to FIGS. 8a-8b, the length of the second T-shape pattern 422 is arranged longer than that of the first T-shape pattern 421, for example, the length of the horizontal portion thereof is 300 um, and the width of the vertical portion thereof is 50 um. The length of the second cover pattern 432 is configured shorter than that of the first cover pattern 431, for example, the length is 300 um. Moreover, the space between the second T-shape pattern 422 and the second cover pattern 432 is the same with that of the first T-shape pattern 421 and the first cover pattern 431. More preferably, the total length of the second T-shape pattern 422, the second cover pattern 432, and the space therebetween is identical with that of the first photo-mask. During the etching of the second photolithography, the vertical portion of the second T-shape pattern 422 extends to the area of the first cover pattern 431 maintained in the first photolithography, so as to be etched at the fresh area. After the second photolithography, the obtained pattern is the same with that of the second photo-mask 2.

In such a design, when perform the second photolithography, the second T-shape pattern 422 is formed regularly on the fresh area that is not etched at the last etching. Thus, the position and the line of the second T-shape pattern 422 are still clear. That is, the straight line edge of the second T-shape pattern 422 will not deviate or overlap with that of the first T-shape pattern 421. Thus, it won't affect the measurement. Thus an accurate frame of reference is maintained and protected.

Similarly, as shown in FIG. 8c, the third photo-mask 3 with a third pattern is used in a third photolithography, which includes a third layer 443 of the ABS pattern 407 and a third T-shape pattern 423. In this process, the horizontal portion's length of the third T-shape pattern 423 is longer than that of the second T-shape pattern 422, for example, 500 um, so as to make the vertical portion's length extend to the fresh area of the second cover pattern 432. During the third photolithography, the vertical portion of the third T-shape pattern 423 extends to the second cover pattern 432 maintained in the second photolithography, so as to be etched at the fresh area. After the third photolithography, the third layer of the ABS pattern 407 is made. That's, the whole photolithography process has been terminated, thereby obtaining the ABS pattern 407 shown in FIG. 7a or FIG. 7b.

Based on the second photolithography, a fresh area not being etched, that is, the area of the second cover pattern 432 is reserved, which makes the straight line of the third T-shape pattern 423 is clear and will not deviate or overlap with that in the last photolithography. Thus, it won't affect the measurement. Thus, an accurate and clear frame of reference is maintained and protected. More concretely, the straight lines 451, 452 is clear, which can be served as a frame of reference for measuring the position of the pole tip of the ABS pattern edge. In other words, the measuring accuracy is improved greatly in such a design.

As explained above, the cover pattern is beneficial to make sure the T-shape pattern not be vitiated, which will not confuse the operator when find a straight line as a frame of reference for measuring. Thus, the measuring accuracy is improved and the measuring speed is advanced.

Commonly, when a disk drive operates, two sets of sliders are flying above the upside and the downside of a rotating disk synchronously. And the sliders on the two sides of the disk are different slightly inside and outside, which are difficult to distinguish by vision. Thus, in the present invention, an identification mark is formed on the ABS of the row bar used for distinguishing the upside or the downside sliders.

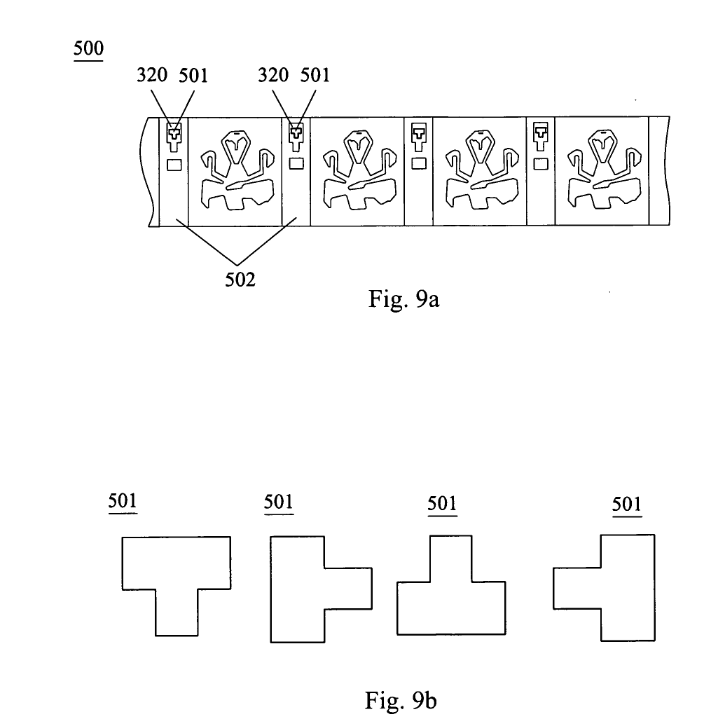

FIG. 9a shows a row bar with an identification mark according to a third embodiment of the present invention. The structure of the row bar 500 is similar to the first embodiment roughly, merely a difference is that, the row bar 500 further includes an identification mark formed on the slider cutting area 502. Concretely, the identification mark is formed on the T-shape pattern 320. More concretely, the identification mark is a T-shape mark 501 for marking the slider located on the upside of the disk. With regard to the disposing direction of the T-shape mark 501, it can change the artificially. For example, the T-shape mark 501 has several variable disposing directions as shown in FIG. 9b, which can indicate different types of row bars.

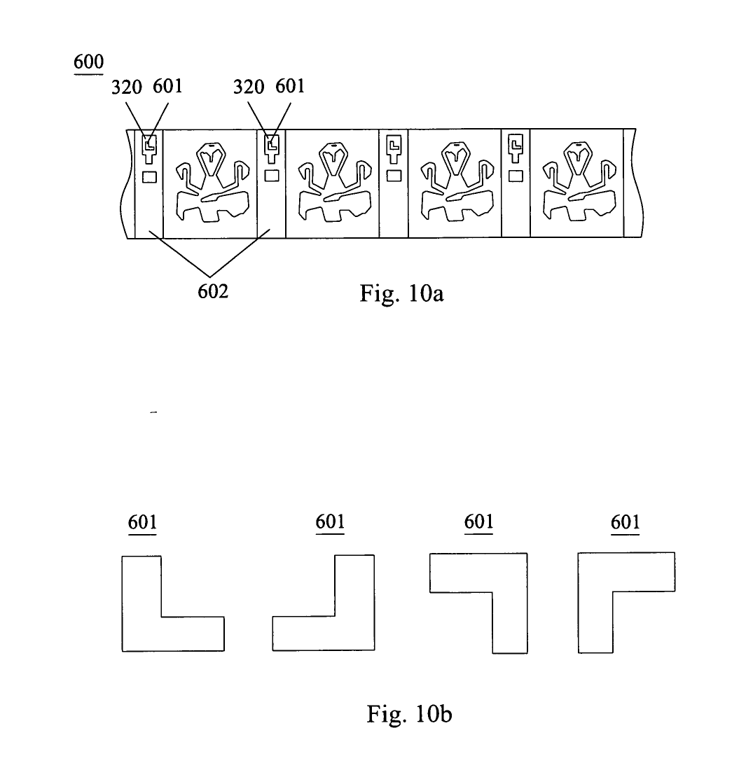

FIG. 10a shows a row bar with an identification mark according to a fourth embodiment of the present invention. The structure of the row bar 600 is similar to the first embodiment roughly, merely a difference is that, the row bar 600 further includes an identification mark formed on the slider cutting area 602. Concretely, the identification mark is formed on the T-shape pattern 320. More concretely, the identification mark is an L-shape mark 601 for marking the slider located on the downside of the disk. With regard to the disposing direction of the L-shape mark 601, it can change the artificially. For example, the L-shape mark 601 has several variable disposing directions as shown in FIG. 10b.

As explained above, the T-shape mark and the L-shape mark are formed on the slider cutting area of the row bar respectively, so as to easily distinguish the sliders located on the upside or the downside of the disk by vision. Moreover, the identification marks are simple for memorization to the operator. Therefore, the slider or row bar distinguishing may not confuse or mistake, which will decrease the error rate.

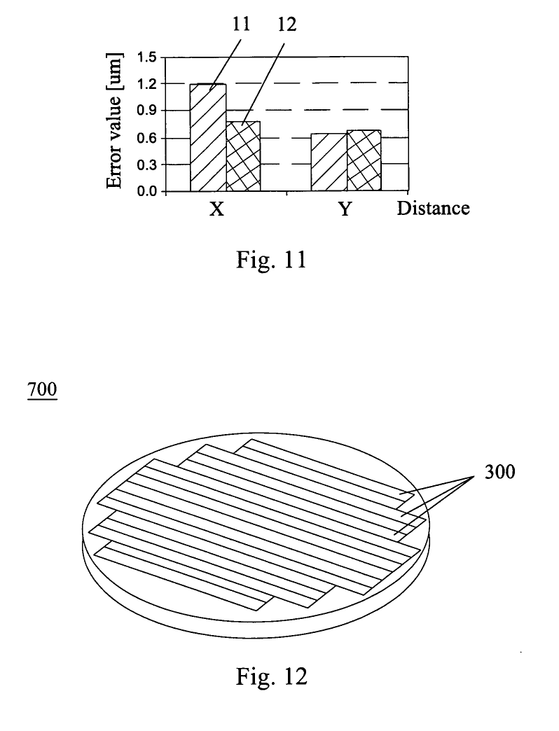

In conclusion, compared with the prior art, the present invention includes a regular measuring pattern with straight lines formed on the slider cutting area of the row bar, which is served as a frame of reference for measuring the position of the pole tip and the ABS pattern. When measure the row bar, the operator only measures the distance between the straight line of the pole tip, so as to measure out that whether the pole tip position and the ABS pattern position complies with the manufacturing specification. In such a design, the measuring process is simplified and is easy to perform, moreover, the measuring accuracy is improved greatly and the error rate is decreased evidently and, in turn, improves the performance of the slider. A comparison chart of measurement error of the present invention and the prior art is shown in FIG. 11 As shown in FIG. 11, the rectangle with oblique line shadow 11 indicates the prior art, and the rectangle with quadrate shadow 12 indicates the present invention. The two sets data shows the distances X, Y shown in FIG. 4 respectively. Compared with the prior art, the measurement error of the present invention is much smaller.

FIG. 12 shows a wafer 700 having several rows bars 300 according to an embodiment of the present invention. As shown, the wafer 700 carries a plurality of row bars 300 formed thereon. As the detailed structure of the row bar 300 has been described in the first embodiment, thus a same description is omitted here. It should be noticed that, the row bars described in the above embodiments are suitable here. The wafer 700 carrying a row bar with equivalent arrangements is included within scope of the invention.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A row bar having a plurality of slider forming areas collocated and slider cutting areas formed between two adjacent slider forming areas respectively, the slider forming areas are eventually cut into individual sliders along the slider cutting areas respectively, each slider having a pole tip embedded therein and an air bearing surface pattern on an air bearing surface facing to a disk, wherein
a regular measuring pattern with straight line is formed on at least one of the slider cutting areas, to serve as a frame of reference for measuring the position of the pole tip and the air bearing surface pattern.

2. The row bar as claimed in claim 1, wherein the regular measuring pattern is a T-shape pattern, which has a horizontal portion and a vertical portion perpendicular to each other.

3. The row bar as claimed in claim 2, wherein the horizontal portion has a width between 5 um to 200 um, and the vertical portion has a length between 10 um to 1000 um.

4. The row bar as claimed in claim 1, wherein the regular measuring pattern is a cross-shape pattern or an L-shaped pattern.

5. The row bar as claimed in claim 1, wherein the row bar further comprises a cover pattern formed below the regular measuring pattern.

6. The row bar as claimed in claim 1, wherein the row bar further comprises an identification mark formed on the slider cutting area to identify the different position of the slider relative to a disk.

7. The row bar as claimed in claim 6, wherein the identification mark is formed on the regular measuring pattern.

8. The row bar as claimed in claim 6, wherein the identification mark is a T-shape mark for marking a slider located on the upside of the disk.

9. The row bar as claimed in claim 6, wherein the identification mark is an L-shape mark for marking a slider located on the downside of the disk.

10. A wafer carrying at least a row bar formed thereon, the row bar having a plurality of slider forming areas collocated and slider cutting areas formed between two adjacent slider forming areas respectively, the slider forming areas are eventually cut into individual sliders along the slider cutting areas respectively, each slider having a pole tip embedded therein and an air bearing surface pattern on an air bearing surface facing to a disk, wherein
at least a regular measuring pattern with straight line is formed on one of the slider cutting areas, to serve as a frame of reference for measuring the position of the pole tip and the air bearing surface pattern.

11. The wafer as claimed in claim 10, wherein the regular measuring pattern is a T-shape pattern, which has a horizontal portion and a vertical portion perpendicular to each other.

12. The wafer as claimed in claim 11, wherein the horizontal portion has a width between 5 um to 200 um, and the vertical portion has a length between 10 um to 1000 um.

13. The wafer as claimed in claim 10, wherein the regular measuring pattern is a cross-shape pattern or an L-shaped pattern.

14. The wafer as claimed in claim 10, wherein the row bar further comprises a cover pattern formed below the regular measuring pattern.

15. The wafer as claimed in claim 10, wherein the row bar further comprises an identification mark formed on the regular measuring pattern to identify the position of the slider relative to a disk.

16. The wafer as claimed in claim 15, wherein the identification mark is formed on the regular measuring pattern.

17. The wafer as claimed in claim 15, wherein the identification mark is a T-shape mark for marking a slider located on the upside of the disk.

18. The wafer as claimed in claim 15, wherein the identification mark is an L-shape mark for marking a slider located on the downside of the disk.
